(19) United States
(12) Patent Application Publication
(10) Pub. No.: US 2018/0342881 A1
(43) Pub. Date: Nov. 29, 2018

(54) Storage System for a Vehicle

(71) Applicant: Bayerische Motoren Werke Aktiengesellschaft, Muenchen (DE)

(72) Inventors: Andre Schmitz, Muenchen (DE); Dieter Ziegltrum, Vaterstetten (DE); Hajo Meinert, Muenchen (DE)

(21) Appl. No.: 16/052,485

(22) Filed: Aug. 1, 2018

Related U.S. Application Data
(63) Continuation of application No. PCT/EP2017/051374, filed on Jan. 24, 2017.

(30) Foreign Application Priority Data
Feb. 2, 2016 (DE) 10 2016 201 520.6

(51) Int. Cl. H02J 7/00; B60L 11/18

(52) U.S. Cl. CPC H02J 7/0024; B60L 11/1877; B60L 11/1855; B60L 11/1805

(57) ABSTRACT

A storage system configured to deliver electric power for propulsion of a vehicle includes a first storage module with at least N first sub-modules for the storage of electrical energy, where N>1, where the first storage module includes a switching unit to connect the N sub-modules in series, forming a series circuit, when the storage system is in a charge mode, and to connect the N sub-modules in parallel, forming a parallel circuit, when the storage system is in a drive mode. The storage system also includes a second storage module with at least one second sub-module for the storage of electrical energy, where the second storage module comprises a DC voltage converter which is configured to couple the second sub-module with the first storage module. A control unit is configured to control the switching unit and the DC voltage converter.

### CROSS REFERENCE TO RELATED APPLICATIONS

This application is a continuation of PCT International Application No. PCT/EP2017/051374, filed Jan. 24, 2017, which claims priority under 35 U.S.C. § 119 from German Patent Application No. 10 2016 201 520.6, filed Feb. 2, 2016, the entire disclosures of which are herein expressly incorporated by reference.

### BACKGROUND AND SUMMARY OF THE INVENTION

The invention relates to a storage system for an at least partially electrically powered vehicle. The invention in particular relates to a storage system with a flexible storage capacity, which can be charged to relatively high charging capacities.

At present, in electrically powered vehicles, e.g. in PHEV vehicles (Plug-in Hybrid Electric Vehicles) or in entirely electrically powered vehicles (BEV, or Battery Electric Vehicles), an energy store comprised of one or more individual battery cells or storage cells is employed as an energy source. The battery cells are generally individual lithium-ion cells. These are connected to one another in series, or in a combination of series and parallel circuits. The total number and the type of interconnection of the battery cells determine the energy available, and thus the range of an electrically powered vehicle.

The charging of an energy store of this type is typically executed by means of connection to an external charging station, which is connected to an electricity supply network. The available connection capacity (charging capacity) for the charging of the energy store can thus be dependent upon the charging station. Charging with a direct current can be described as rapid charging, with a charging capacity of 50 kW or more. Charging with an alternating current permits charging capacities in the range of 3.6 kW to 22 kW.

High charging capacities advantageously permit the elimination of prolonged immobilization periods of the vehicle for the recharging of the energy store. One option for increasing the charging capacity is DC charging with an increased charging voltage (e.g. 800 V or more, rather than the 460 V or less employed at present). However, the use of a higher charging voltage involves changes to the HV (high-voltage) storage technology employed. In general, the employment of energy stores with correspondingly increased rated voltages is not desirable (e.g. on the grounds of the IGBTs, employed in the drive train, of an inverter, which IGBTs can only be used up to specific maximum limiting voltages (such as 650 V, 900 V or 1200 V)).

DE102014004790A1 describes an energy store for a vehicle, wherein a changeover matrix is employed for the serial interconnection of parallel-connected strings in the energy store, such that the voltage level of the energy store is doubled (where two parallel-connected strings are employed). However, the energy store described in DE102014004790A1 is disadvantageous with respect to the different storage capacities which it can deliver. In particular, the scalability of the energy store and the achievable electrical range are limited by the storage architecture described in DE102014004790A1.

The technical object of the present document concerns the provision of a flexibly dimensionable storage system for an at least partially electrically powered vehicle, which permits high storage capacities.

According to one aspect, a storage system for the delivery of electric power for the propulsion of a vehicle is described. In particular, the electric power can be employed for the operation of an electrical driving machine of the vehicle. Where applicable, moreover, electric power can be recovered by the electrical machine of the vehicle during braking processes and stored in the storage system.

The storage system comprises a first storage module with at least N first sub-modules for storing electrical energy. Each sub-module can comprise at least one string of (typically a plurality of) storage cells. Where applicable, a sub-module can also comprise parallel-connected storage cells. The number N of first sub-modules in the first storage module is a whole number, and preferably an even number, wherein N>1. Preferably, N can be equal to 2, such that an advantageous compromise is achieved between the charging voltage (for the charging of the storage system) and the driving voltage (for the operation of the drive system of the vehicle (in particular with respect to the power transistors installed in the vehicle). The N first sub-modules can be of identical design (in particular with respect to the respective rated voltage and/or the respective storage capacity). The first storage module further comprises a switching unit (having a plurality of switches), which is designed to connect the N sub-modules in series, in a charge mode, and to connect the N sub-modules in parallel, in a drive mode. In charge mode, the first storage module is typically charged on an external charging station. Conversely, in drive mode, the first storage module is typically coupled to a drive system of the vehicle (comprising e.g. an inverter and an electrical drive machine), such that the first storage module can deliver electrical energy to the drive system, or permit the take-up thereof by the drive system.

The storage system further comprises a second storage module with at least one second sub-module for storing electrical energy. The second sub-module can comprise a string of (where applicable, partially parallel-connected) storage cells. The number of (series-connected) storage cells in a second sub-module typically differs from the number of (series-connected) storage cells in a first sub-module. The second storage module further comprises a (bidirectional) DC voltage converter, which is designed for the coupling of the second sub-module to the first storage module. The second storage module can thus take up electrical energy via the DC voltage converter (and store it in the second sub-module), or deliver electrical energy from the second sub-module (e.g. for the operation of the drive system of the vehicle).

The storage system further comprises a control unit, which is designed to control the switching unit and the DC voltage converter. The control unit can be designed to actuate the switching unit such that, in charge mode, the series circuit comprised of the N first sub-modules is connected in parallel with a charging socket of the vehicle, by means of which the storage system can be connected to an external charging station. A relatively rapid charging process, with a relatively high charging voltage U_{L}, can thus be executed. The control unit can further be designed to actuate the DC voltage converter in charge mode, for the adjustment of electric power which is delivered to, or tapped off from, the second sub-module, in accordance with a target capacity. The distribution of charging capacity between the first storage module and the second storage module, in charge mode, can thus be adjusted by the actuation of the DC voltage converter.

In a corresponding manner, the control unit can be designed to actuate the switching unit of the first storage module such that, in drive mode, the parallel circuit of the N first sub-modules is connected in parallel with a drive system of the vehicle. Reliable operation of the vehicle can thus be achieved with a relatively low drive voltage U_{F}. The control unit can further be designed to actuate the DC voltage converter in drive mode, for the adjustment of electric power which is delivered to the second sub-module (e.g. during recovery), or tapped off from the latter, in accordance with a target capacity. The distribution of the drive capacity of the vehicle between the first storage module and the second storage module, in drive mode, can thus be adjusted by the actuation of the DC voltage converter.

By the combination of a first storage module having configurable first sub-modules, and a second storage module having a DC voltage converter, a storage system can be provided which can be charged with a relatively high charging capacity, and which permits the provision of flexible storage capacities.

The drive system of the vehicle can be rated for electrical energy at the drive voltage U_{F}. The N first sub-modules can thus each have a rated voltage which corresponds to the drive voltage U_{F}. Conversely, the second sub-module can have an (arbitrary) rated voltage. The DC voltage converter can then be designed to convert electrical energy between the second rated voltage and the drive voltage U_{F}. The employment of a DC voltage converter thus permits a flexible design of the second storage module, in particular with respect to storage capacity and the technology employed in the second storage module, and thus a flexible design of the storage system as a whole.

A charging station for the charging of the N first sub-modules and of the second sub-module can deliver electrical energy at a charging voltage U_{L}. As a result of the series connection of the N first sub-modules, the charging voltage U_{L} can thus correspond to N times the drive voltage U_{F}, such that high charging capacities can be achieved. For example, the drive voltage U_{F} can be of the order of 400-500 V, and the charging voltage U_{L} can be of the order of 800-1000 V (where N=2).

The second storage module can be arranged in parallel with the first storage module, such that the second storage module (and in particular the DC voltage converter), in charge mode, is arranged in parallel with the charging voltage U_{L} and, in drive mode, is arranged in parallel with the drive voltage U_{F}. The DC voltage converter can then be designed to convert the drive voltage U_{F} or the charging voltage U_{L} into the second rated voltage (or vice versa).

The storage system can further comprise a second switching unit which, in charge mode, is designed to arrange the second storage module either in parallel with one first, or in parallel with a different second sub-quantity of the N first sub-modules. In consequence, the second storage module (and in particular the DC voltage converter), in charge mode, can be arranged in parallel with a partial voltage of the charging voltage U_{L}, thus permitting a moderation of requirements (and thus, inter alia, a reduction of costs) for the DC voltage converter.

The control unit can be designed to actuate the second switching unit such that, in charge mode, the second storage module, in a first phase, is arranged in parallel with the first sub-quantity and, in a second phase, the second storage module is arranged in parallel with the second sub-quantity. The lengths of the first phase and the second phase can thus be selected such that the states of charge of the individual first sub-modules are approximately equal. By the switchover of the second storage module in charge mode, equalizing currents between the N first sub-modules upon the transition to drive mode can be prevented or reduced.

The control unit can be designed to control the DC voltage converter such that the second storage module, on average, has a higher (e.g. thermal) load than the first storage module. Thus, for example, a cooling action of the storage system can be concentrated on the second storage module. Moreover, any wear on the storage system can thus be concentrated on the second storage module. Accordingly, costs, and in particular operating costs of the storage system can be reduced (since e.g. the service life of the first storage module can be increased).

The first storage module can have a first storage capacity and the second storage module can have a second storage capacity. The first storage capacity can be greater than the second storage capacity (e.g. by a factor of 2, 3, 4 or more). In one time interval, the first storage module can have a first throughput of electrical energy relative to the first storage capacity, and the second storage module can have a second throughput of electrical energy relative to the second storage capacity (in particular for the charging and/or discharging of the respective storage module). The throughput of electrical energy can thus represent a load for the respective storage module. The control unit can be designed to control the DC voltage converter such that, in the time interval, the second throughput is greater than the first throughput. A loading of the storage system can thus be concentrated on the second storage module.

According to a further aspect, a method for operating a storage system for an electrically powered vehicle is described. The storage system comprises a first storage module having at least N first sub-modules for the storage of electrical energy, wherein N>1. The storage system further comprises a second storage module having at least one second sub-module for the storage of electrical energy, and having a DC voltage converter.

In a charge mode, the method comprises the arrangement of the N first sub-modules in series, in order to charge the first storage module with a charging voltage U_{L}, by means of the N first sub-modules arranged in series and the arrangement of the DC voltage converter in parallel with at least a proportion of the N first sub-modules arranged in series, in order to charge the second sub-module. Moreover, in a drive mode, the method comprises the arrangement of the N first sub-modules in parallel with each other, in order to operate the first storage module at a drive voltage U_{F} by means of the N first sub-modules arranged in parallel, and the arrangement of the DC voltage converter in parallel with the N first sub-modules arranged in parallel.

According to a further aspect, a vehicle (in particular a road vehicle, e.g. a passenger vehicle, a heavy goods vehicle or a motorbike) which incorporates the storage system described in the present document is described.

It should be observed that the methods, devices and systems described in the present document can be employed in isolation, or in combination with other methods, devices and systems described in the present document. Moreover, any aspects of the methods, devices and systems described in the present document can be mutually combined in a variety of ways. In particular, the features in the claims can be mutually combined in a variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1a and 1b show different states of an exemplary storage system, having a first storage module and a second storage module.

FIGS. 2a, 2b and 2c show different states of a further exemplary storage system, having a first storage module and a second storage module.

FIG. 3 shows a sequence diagram of an exemplary method for the operation of a storage system.

### DETAILED DESCRIPTION OF THE DRAWINGS

As mentioned above, the present document concerns the provision of a storage system for a vehicle which provides flexible storage capacities, and can be charged to relatively high charging capacities. In this regard, figures la and lb show a storage system 100 having a first storage module 110 and a second storage module 120. The first module 110 can be designated as a basic storage module, and the second module 120 can be designated as a supplementary storage module. The first module 110 comprises N first sub-modules 111, 112 which, by means of a changeover unit 112, can be mutually connected in series or in parallel (where N is a whole (even) number, wherein N>1, in particular N=2). A second module 120, comprising one or more second sub-modules 121, is arranged in parallel with the first module 110. The one or more second sub-modules 121 are connected to the first module 110 via a DC voltage converter 122.

As a basic storage module, a first module 110 having at least two or more parallel-connected first sub-modules 111, 112 is thus employed, wherein a first sub-module 111, 112 comprises one or more storage cells or strings of storage cells. A second module 120 which, if required, permits greater scalability, is connected in parallel with the first module 110.

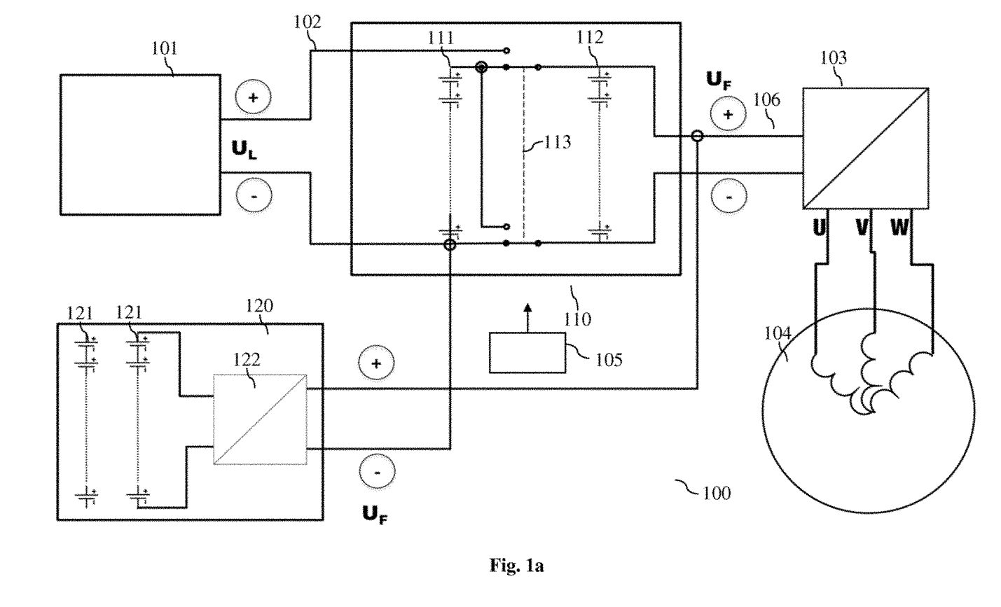

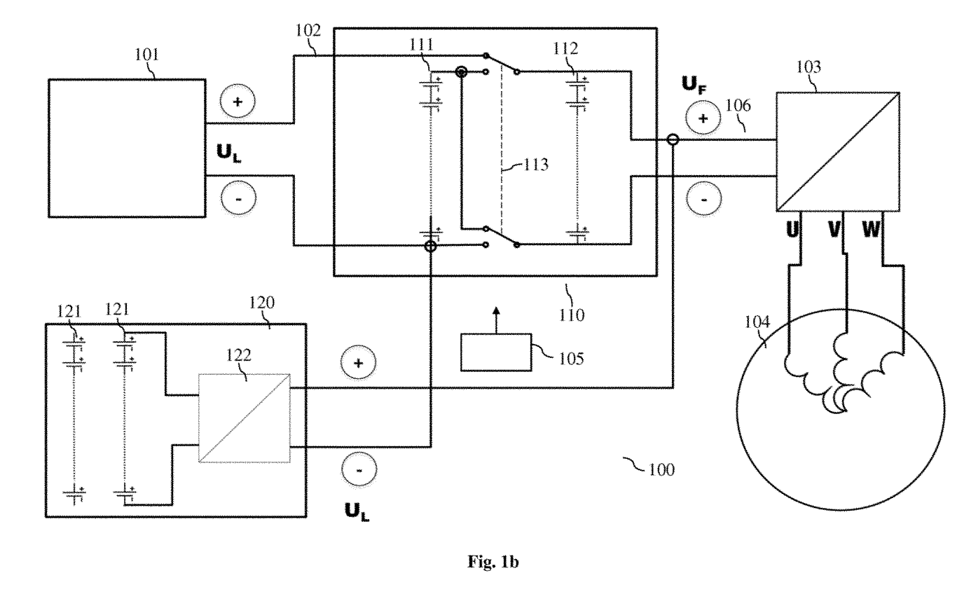

The energy storage system 100 can be operated in two different modes, a “drive” or driving mode, and a “charge” or charging mode. FIG. 1a represents the “drive” operating mode. In this case, the voltage level of the electrical drive system 103, 104 (i.e. the drive voltage U_{F}) corresponds to the voltage level of a first sub-module 111, 112 of the first module 110 (e.g. a voltage of up to 460 V). This voltage level is dependent upon the number of series-connected storage cells in a first sub-module 111, 112. Typically, the first sub-modules 111, 112 are therefore rated in accordance with the requirements of the drive system 103, 104 (i.e. in particular of the inverter 103 and/or of the electrical drive machine 104) of a vehicle. Additionally, in a second sub-module 121 of the second module 120, any desired and, where applicable, smaller number of storage cells can be connected in series, and the DC voltage converter 122 (e.g. a bidirectional step-up converter) can be employed for the adjustment of the voltage level of the one or more second sub-modules 121 to the voltage level U_{F} (e.g. up to 460 V) in the on-board system 106.

If the vehicle is connected to a charging station 101 (e.g. by means of a charging cable 102), the vehicle switches over to “charge” mode by actuation of the changeover unit 113, such that the parallel-connected first sub-modules 111, 112 from figure 1a are connected in series (as represented in FIG. 1b). The changeover unit 113 can be actuated by means of a control unit 105. By the series connection of the N first sub-modules 111, 112, the charging voltage U_{L} on the charging cable 102 increases by a factor of N in relation to the drive voltage U_{F} on the on-board network 106. By means of the changeover unit 113, the second module 120 can also be connected in parallel with the charging station 102 and with the charging voltage U_{L}, such that the DC voltage converter 122 now operates with an increased voltage range U_{L} (e.g. up to 1000 V).

During a charging process (as per FIG. 1b ), as a result of the increased charging voltage U_{L}, the first module 110 takes up an increased charging capacity. By means of the DC voltage converter 122, the one or more second sub-modules 121 of the second module 120 can be supplied with the requisite charging capacity.

In a charging process, different charging strategies can be employed:

All the storage modules 110, 120 can be charged simultaneously, where applicable with different charging capacities. The different charging capacities can be set by means of the DC voltage converter 122. The charging capacities can be set such that all the storage modules 110, 120 are fully charged in a simultaneous manner.

The first module 110 can be charged with a specific charging capacity up to a maximum charging capacity, and the second module 120 can be charged with an overload capacity, such that the second module 120 is charged more rapidly than the first module 110. The DC/DC converter 122, following achievement of the maximum state of charge on the second module 120, can set the charging capacity of the second module 120 to 0 W.

The first module 110 can be charged with a charging capacity up to the maximum charging capacity, and the second module 120 can be charged with a capacity which is so low that the second module 120 is charged more slowly than the first module 110. As soon as the first module 110 is fully charged, the charging process stops, such that the second module 120 is not fully charged.

It is possible for only the first module 110 to be charged. Where applicable, a transfer of charge can be executed from the first module 110 to the second module 120, wherein the charge transfer process can be controlled by the DC voltage converter 122. The DC voltage converter 122 can be controlled by means of the control unit 105.

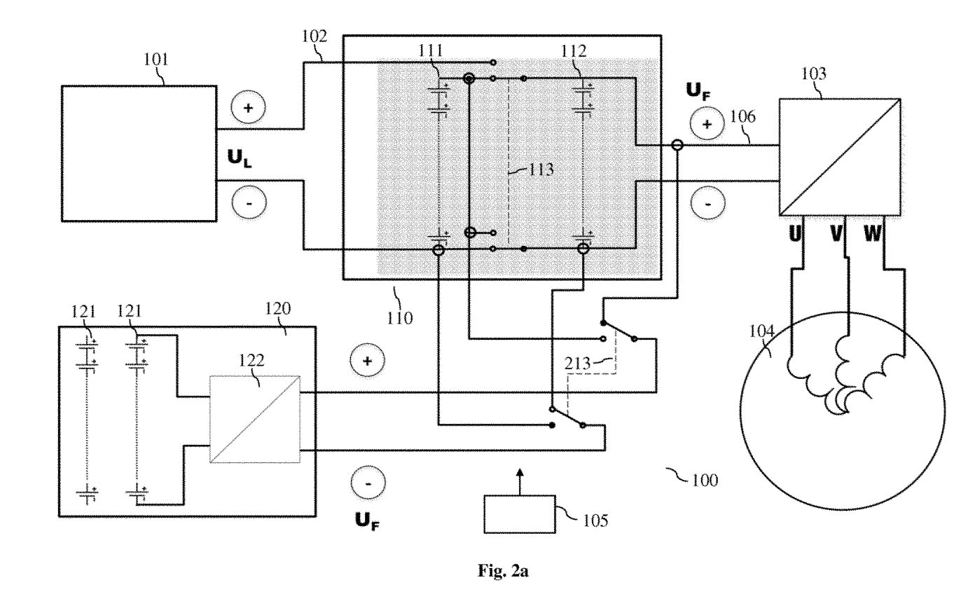

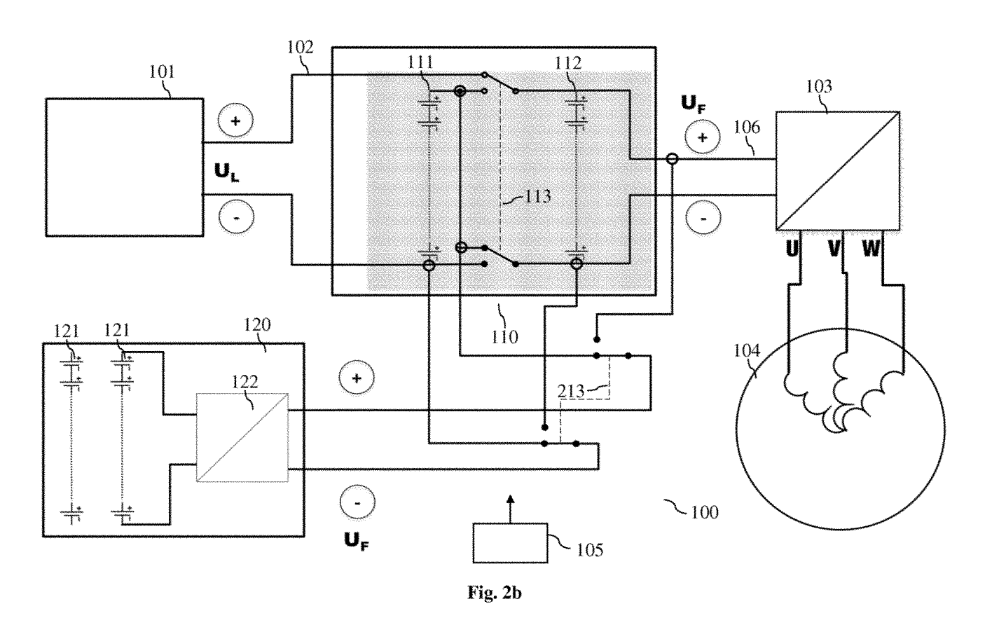

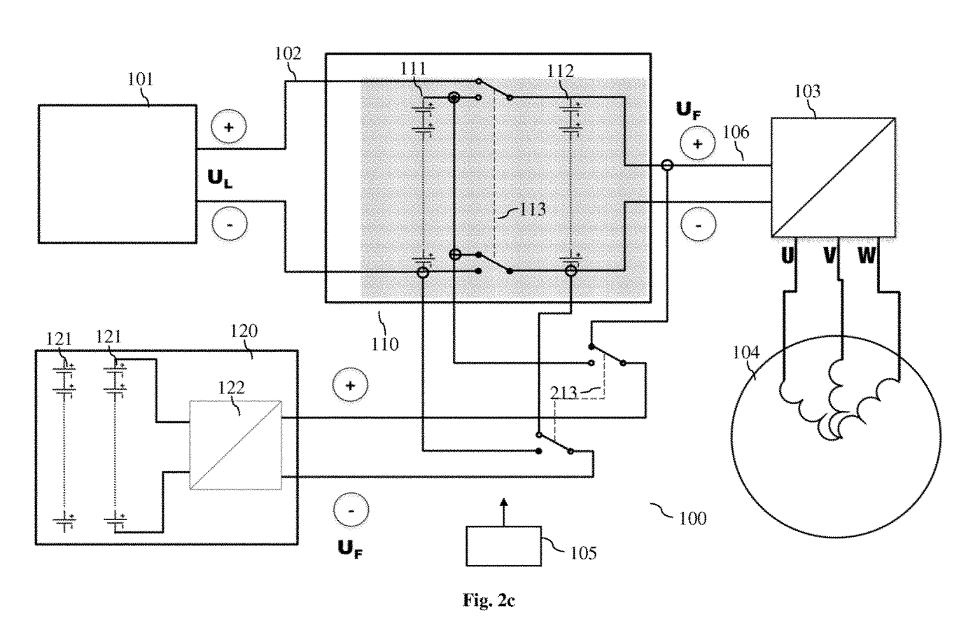

Following the completion of the charging process, the parallel connection of the first sub-modules 111, 112 of the first module 110 can be restored for operation in drive mode (as represented in figure la), such that the voltage level is reduced (to the drive voltage U_{F}). The DC/DC converter can adjust to the lower voltage level U_{F} accordingly. During this changeover process, e.g. as a result of variations in the ageing of cells, different voltage levels can occur in the first sub-modules 111, 112 of the first module 110 such that, upon the parallel connection thereof, unwanted equalizing currents flow. Equalizing currents of this type can be prevented by the variants of the storage system 100 represented in FIGS. 2a, 2b and 2c.

A further variant of a storage system 100 is shown in FIGS. 2a, 2b and 2c. This storage system 100 comprises a further second changeover unit 213, which permits the DC/DC converter 122, even in charge mode, only to be operated up to a voltage level which corresponds to the drive voltage U_{F} (e.g. 460 V). To this end, the second module 120, in charge mode, can be connected in parallel with at least one or with an even-numbered multiple of parallel-connected first sub-modules 111, 112 (as represented in FIGS. 2b and 2c) by means of the second changeover unit 213.

FIG. 2a shows the storage module 100 in the “drive” operating mode, wherein the first sub-modules 111, 112 of the first storage module 110 are mutually arranged in parallel, and wherein the first storage module 110 and the second storage module 120 are coupled to the on-board network 106 in a mutually parallel arrangement.

The “charge” operating mode can be subdivided into different phases, in which the second storage module 120 is arranged in parallel with different first sub-modules 111, 112 of the first storage module 110. In other words, during the charging process, a changeover can be executed in the location of the parallel connection of the second module 120 with at least one or with an even-numbered multiple of parallel-connected first sub-modules 111, 112 of the first module 110. The change of location can be employed for the prevention or equalization of different states of charge on the first sub-modules 111, 112. If, during the charging process, the second module 120 is connected in parallel with a first sub-module 111, 112, the second module 120 taps charging capacity from this first sub-module 111, 112 and/or discharges this first sub-module 111, 112. This could lead to the different sub-modules 111, 112 in the first module 110 showing different states of charge (SOC). By the changeover in the location of the second storage module 120, the uneven loading of the first sub-modules 111, 112 can be compensated such that, upon the completion of the charging process (with no substantial equalizing currents between the first sub-modules 111, 112 of the first storage module 110), the parallel connection of the first sub-modules 111, 112 can be restored (as represented in FIG. 2a).

Different states of charge on the first sub-modules 111, 112 are also attributable to other causes (in particular to variation in the ageing of cells in the first sub-modules 111, 112). By means of the changeover in the location of the second storage module 120, a difference in charge or a difference in voltage between the first sub-modules 111, 112 can be compensated prior to the parallel connection thereof.

FIG. 2b shows a first phase of the charging process, wherein the second module 120 is arranged in parallel with the first sub-module 111, and FIG. 2c shows a second phase of the charging process, wherein the second module 120 is arranged in parallel with the first sub-module 112. The changeover between the two phases is executed by means of the switches of the switching unit 213.

In the storage systems 100 described, the DC/DC converter 122 can be configured as a bidirectional step-up converter. Optionally, the DC/DC converter 122, by trimming or in an inefficient form of operation, can be employed as a HV storage heater.

The combined employment of a basic storage module 110 with a facility for the changeover of the first sub-modules 111, 112, and a supplementary storage module 120 with a DC voltage converter 122, permits an unrestricted scalability and the provision of different electrical ranges and drive capacities. Accordingly, a DC voltage converter 122 of relatively small dimensions can be employed, such that a cost-effective, compact, low-weight and energy-efficient storage system 100 can be achieved.

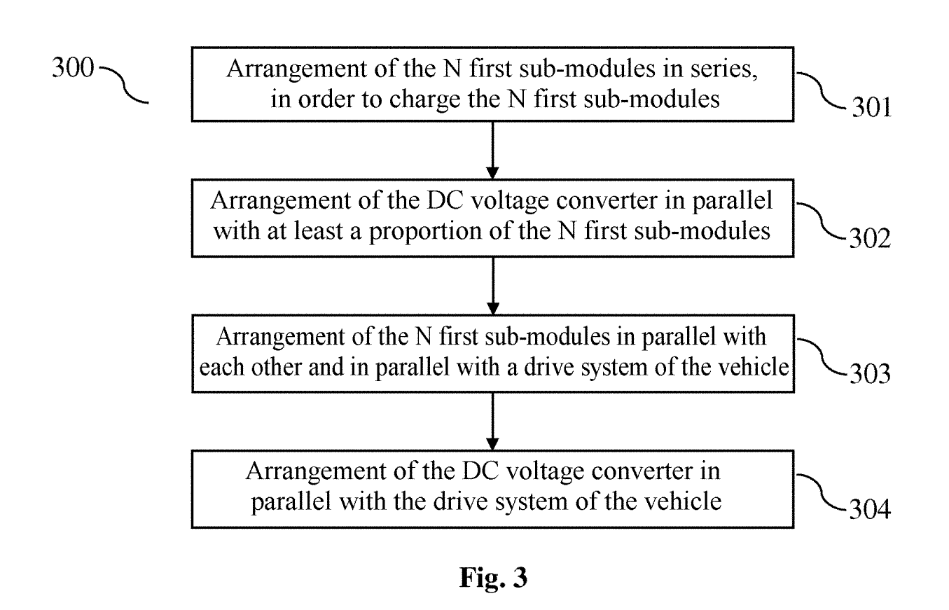

FIG. 3 shows a sequence diagram of an exemplary method 300 for operating a storage system 100 for an electrically powered vehicle. The storage system 100 comprises a first storage module 110 having at least N first sub-modules 111, 112 for the storage of electrical energy. N is a whole number, typically an even number, wherein N>1. The storage system 100 further comprises a second storage module 120 having at least one second sub-module 121 for the storage of electrical energy, and having a DC voltage converter 122.

The method 300 comprises, in a charge mode for the charging of the storage system 100, the arrangement 301 of the N first sub-modules 111, 112 in series, in order to charge the first storage module 110 with a charging voltage U_{L} by means of the N first sub-modules 111, 112 arranged in series. To this end, the first storage module 110, with the series-connected arrangement of the N first sub-modules 111, 112, can be connected in parallel with a charging station 101. The arrangement 301 of the N first sub-modules 111, 112 in series can be executed by means of a switching unit or changeover unit 113 of the storage system 100.

The method 300 further comprises, in charge mode, the arrangement 302 of the DC voltage converter 122 in parallel with at least a proportion of the N first sub-modules 111, 112 arranged in series, where applicable in order to charge the second sub-module 121. The DC voltage converter 122 can be employed for the setting of a charging capacity for the second sub-module 121 (e.g. in accordance with a target charging capacity).

The method 300 further comprises, in a drive mode, in which the storage system 100 is arranged in parallel with a drive system 103, 104 of the vehicle, the arrangement 303 of the N first sub-modules 111, 112 in parallel with each other, and in parallel with the drive system 103, 104 of the vehicle. The first storage module 110 can thus be operated with a drive voltage U_{F} by means of the N first sub-modules 111, 112 arranged in parallel. The drive voltage U_{F} is typically N times smaller than the charging voltage U_{L}.

The method 300 can further comprise the arrangement 304 of the DC voltage converter 122 in parallel with the N first sub-modules arranged in parallel, and in parallel with the drive system 103, 104 of the vehicle.

The present invention is not limited to the exemplary embodiments illustrated. In particular, it should be observed that the description and the figures are only intended to illustrate the principle of the proposed methods, devices and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A storage system configured to deliver electric power for propulsion of a vehicle, wherein the storage system comprises,
a first storage module with at least N first sub-modules for the storage of electrical energy, where N>1, wherein the first storage module comprises a switching unit configured to connect the N sub-modules in series, forming a series circuit, when the storage system is in a charge mode, and to connect the N sub-modules in parallel, forming a parallel circuit, when the storage system is in a drive mode;
a second storage module with at least one second sub-module for the storage of electrical energy, wherein the second storage module comprises a DC voltage converter which is configured to couple the second sub-module with the first storage module; and
a control unit which is configured to control the switching unit and the DC voltage converter.

2. The storage system as claimed in claim 1, wherein
a drive system of the vehicle is rated for electrical energy at a drive voltage;
the N first sub-modules each have a rated voltage which corresponds to the drive voltage;
the second sub-module has a second rated voltage; and
the DC voltage converter is configured to convert electrical energy between the second rated voltage and the drive voltage.

3. The storage system as claimed in claim 2, wherein
a charging station for the charging of the N first sub-modules and the second sub-module delivers electrical energy at a charging voltage; and
the charging voltage corresponds to N times the drive voltage.

4. The storage system as claimed in claim 1, wherein the control unit is configured to at least one of:
actuate the switching unit such that, in the charging mode, the series circuit comprised of the N first sub-modules is connected in parallel with a charging socket of the vehicle, wherein the storage system is connectable to a charging station by the charging socket, and
actuate the switching unit such that, in the drive mode, the parallel circuit of the N first sub-modules is connected in parallel with a drive system of the vehicle.

5. The storage system as claimed in claim 2, wherein the control unit is configured to at least one of:
actuate the switching unit such that, in the charging mode, the series circuit comprised of the N first sub-modules is connected in parallel with a charging socket of the vehicle, wherein the storage system is connectable to a charging station by the charging socket, and
actuate the switching unit such that, in the drive mode, the parallel circuit of the N first sub-modules is connected in parallel with the drive system of the vehicle.

6. The storage system as claimed in claim 3, wherein the control unit is configured to at least one of:
actuate the switching unit such that, in the charging mode, the series circuit comprised of the N first sub-modules is connected in parallel with a charging socket of the vehicle, wherein the storage system is connectable to the charging station by the charging socket, and
actuate the switching unit such that, in the drive mode, the parallel circuit of the N first sub-modules is connected in parallel with a drive system of the vehicle.

7. The storage system as claimed in claim 1, wherein the control unit is configured to actuate the DC voltage converter in at least one of the charge mode and the drive mode such that electric power that is delivered to, or tapped off from, the second sub-module is adjusted in accordance with a target capacity.

8. The storage system as claimed in claim 2, wherein the control unit is configured to actuate the DC voltage converter in at least one of the charge mode and the drive mode such that electric power that is delivered to, or tapped off from, the second sub-module is adjusted in accordance with a target capacity.

9. The storage system as claimed in claim 3, wherein the control unit is configured to actuate the DC voltage converter in at least one of the charge mode and the drive mode such that electric power that is delivered to, or tapped off from, the second sub-module is adjusted in accordance with a target capacity.

10. The storage system as claimed in claim 4, wherein the control unit is configured to actuate the DC voltage converter in at least one of the charge mode and the drive mode such that electric power that is delivered to, or tapped off from, the second sub-module is adjusted in accordance with a target capacity.

11. The storage system as claimed claim 1, wherein the storage system comprises a second switching unit which, in the charge mode, is configured to arrange the second storage module either in parallel with one first, or in parallel with a different second sub-quantity of the N first sub-modules.

12. The storage system as claimed in claim 11, wherein the control unit is configured to actuate the second switching unit such that, in the charge mode:
the second storage module, in a first phase, is arranged in parallel with the first sub-quantity; and
in a second phase, the second storage module is arranged in parallel with the second sub-quantity.

13. The storage system as claimed in claim 1, wherein the control unit is configured to control the DC voltage converter such that the second storage module, on average, has a higher load than the first storage module.

14. The storage system as claimed in claim 2, wherein the control unit is configured to control the DC voltage converter such that the second storage module, on average, has a higher load than the first storage module.

15. The storage system as claimed in claim 3, wherein the control unit is configured to control the DC voltage converter such that the second storage module, on average, has a higher load than the first storage module.

16. The storage system as claimed in claim 1, wherein
the first storage module has a first storage capacity, and the second storage module has a second storage capacity;
in a time interval, the first storage module has a first throughput of electrical energy relative to the first storage capacity, and the second storage module has a second throughput of electrical energy relative to the second storage capacity; and
the control unit is configured to control the DC voltage converter such that, in the time interval, the second throughput is greater than the first throughput.

17. A method for operating a storage system for an electrically powered vehicle, wherein the storage system comprises a first storage module having at least N first sub-modules for the storage of electrical energy, where N>1, and wherein the storage system comprises a second storage module having at least one second sub-module for the storage of electrical energy, and having a DC voltage converter, wherein the method comprises the acts of:
in a charge mode of the storage system,
arranging the N first sub-modules in series to charge the first storage module with a charging voltage by the N first sub-modules arranged in series; and
arranging the DC voltage converter in parallel with at least a proportion of the N first sub-modules arranged in series to charge the second sub-module; and
in a drive mode of the storage system,
arranging the N first sub-modules in parallel with each other in order to operate the first storage module at a drive voltage by the N first sub-modules arranged in parallel; and
arranging the DC voltage converter in parallel with the N first sub-modules arranged in parallel.
